(19) United States
(12) Patent Application Publication
(10) Pub. No.: US 2026/0056402 A1
(43) Pub. Date: Feb. 26, 2026

(54) LIGHT-SHIELDING FILM, LIGHT-SHIELDING MEMBER FORMED USING SAME, LENS UNIT AND CAMERA MODULE

(71) Applicant: SOMAR CORPORATION, Tokyo (JP)

(72) Inventor: Naoki Sakazume, Tokyo (JP)

(21) Appl. No.: 19/102,545

(22) PCT Filed: Jul. 14, 2023
(86) PCT No.: PCT/JP2023/025981

§ 371 Date: Feb. 10, 2025

(30) Foreign Application Priority Data
Oct. 28, 2022 (JP) 2022-172861

(51) Int. Cl. G02B 27/00; G02B 5/00; G02B 5/20; G02B 7/02; G03B 11/00

(52) U.S. Cl. CPC G02B 27/0018; G02B 5/003; G02B 5/206; G02B 7/021; G03B 11/00

(57) ABSTRACT

A light-shielding film capable of suppressing flare ghost, wherein front and back thereof can be distinguished visually. A glossiness degree against a light having an incident angle of 60°is (A), reflectance against a light having a wavelength of 550 nm is (B), an L value in CIELAB color space system by the SCE method is (C) and an optical density (OD) is (D) here. The light-shielding film includes at least first and second light-shielding layers wherein an outermost surface formed with each of the layers have the (A), (B), (C) and (D) of 2% or less, 4.5% or less, 26 or less and 1.0 or more, respectively. Between the outermost surface of the first light-shielding layer and the outermost surface of the second light-shielding layer, a difference of (B) and a difference of (C) are 2% or less and 4 or more, respectively.

### TECHNICAL FIELD

The present invention relates to a light-shielding film, a light-shielding member formed using the same, a lens unit and a camera module.

### BACKGOUND ART

Electronic devices, such as smartphones, tablet terminals and digital cameras, are provided therein with a camera module for photographing an object and converting to an image signal. The camera module is required to remove scattering lights, such as an incident light and a reflection light, which are unnecessary to form an object image on an image pickup element (hereinafter, simply referred to as “unnecessary lights”), to prevent halation, lens flare and ghost, etc. (hereinafter, abbreviated as “flare ghost”) from arising and to improve an image quality of a picked-up image. For this purpose, a light-shielding member for removing unnecessary lights is incorporated in a lens unit to be used in a camera module.

As a light-shielding member of this kind, there have been known those produced by a light-shielding film, obtained by forming a light-shielding layer containing carbon black, lubricant, fine particles and a binder resin on both surfaces of a film substrate, and processed to be a desired shape (for example, the patent document 1).

When producing a light-shielding member in a desired shape from a light-shielding film or when incorporating a produced light-shielding member in a camera module, if it is difficult to distinguish front and back surfaces of the light-shielding film or the light-shielding member, faults in incorporating it or other faults in production may be caused. To distinguish the front and back surfaces, conventionally a coating by an aqueous ink was printed as a mark in a thickness of a level of not affecting optical characteristics of the light-shielding layer (for example, less than 1 μm) on one light-shielding layer of the light-shielding film. The coating by the aqueous ink, however, could fall off, etc. from the light-shielding layer, on which it is formed, due to small stimuli, such as contact, when transferring the light-shielding film or light-shielding member or when incorporating it in a camera module and becomes a contaminated object (which is called “contami”or contamination).

In order to solve the problem by not printing a mark on a light-shielding layer, for example, the patent document 2 discloses a technique of making glossiness degrees of one light-shielding layer and the other light-shielding layer to be less than 10% and making the glossiness degrees different between one light-shielding layer and the other light-shielding layer.

### RELATED ART DOCUMENTS

### Patent Document

Patent Document 1: WO2006/16555

Patent Document 2; Japanese U.S. Pat. No. 6,368,445 (paragraph 0030)

### SUMMARY OF THE DISCLOSED SUBJECT MATTER

In the technique in the patent document 2, since the light-shielding layer does not have any print as a mark, the problem of contamination explained above may be eliminated. However, the light-shielding film and light-shielding member of the technique in the patent document 2 have high glossiness level as less than 10% on both light-shielding layers, so that there is a possibility that an unnecessary light cannot be removed sufficiently even if glossiness degrees are made to be different between both of the light-shielding layers. In a camera module having a lens unit incorporating a light-shielding film or light-shielding member not capable of removing an unnecessary light sufficiently, flair ghost arises to result in deteriorating a quality of a picked-up image.

The present invention was made in consideration of the above circumstances. The present invention has an object thereof to provide a light-shielding film for obtaining a light-shielding member, by which arising of flare ghost can be suppressed in a camera module incorporating a lens unit and front and back thereof can be distinguished visually, and to provide a light-shielding member, lens unit and camera module formed by using the same.

The present inventors conducted studies diligently and found that, when the requirements below are fulfilled, it is effective for distinguishing front and back of a light-shielding member and light-shielding film visually while suppressing arising of flare ghost in a camera module incorporated in a lens unit.
At least a specific first light-shielding layer and a specific second light-shielding layer are included, the respective outermost layer surfaces of the first light-shielding layer and the second light-shielding layer have a plurality of predetermined optical characteristics (extremely low glossiness of 2% or less and a low reflectance of 4.5% or less, in particular).
The first light-shielding layer and the second light-shielding layer having a difference of predetermined optical characteristics (an L value and a reflectance, in particular) in a predetermined range on the respective outermost layer surfaces are used.

The inventors completed the invention provided below based on the new knowledge above and attained the object above.

Below, a glossiness degree against a light having an incident angle of 60°is abbreviated as (A), reflectance against a light having a wavelength of 550 nm is (B), an L value in CIELAB color space system by the SCE method is (C), and an optical density (OD) is (D).

According to the present invention, there is provided a light-shielding film for obtaining a light-shielding member used for optical devices,
comprising at least a first light-shielding layer and a second light-shielding layer,
wherein
the first light-shielding layer and the second light-shielding layer have (A), (B), (C) and (D) of 2% or less, 4.5% or less, 26 or less and 1.0 or more on their outermost surfaces of surfaces formed with the respective layers; and
a difference of the (B) and a difference of the (C) are 2% or less and 4 or more, respectively, between an outermost surface of a surface formed with the first light-shielding layer and an outermost surface of a surface formed with the second light-shielding layer.

The light-shielding film above may include the modes listed below.
A difference of the (A) may be 0.5% or less between an outermost surface of a surface formed with a first light-shielding layer and an outermost surface of a surface formed with a second light-shielding layer.
An outermost surface of a surface formed with a first light-shielding layer may have the (B) of 2.4% or less.
An outermost surface of a surface formed with a second light-shielding layer may have the (B) of 2.8% or more.
An outermost surface of a surface formed with a first light-shielding layer may have the (C) of 18 or less.
An outermost surface of a surface formed with a second light-shielding layer may have the (C) of 17 or more and 25 or less.
An outermost surface of a surface formed with a first light-shielding layer may have the (D) of 2.0 or more.
An outermost surface of a surface formed with a second light-shielding layer may have the (D) of 1.5 or less.

According to the present invention, there is provided a light-shielding member to be used in a lens unit, formed of the light-shielding film explained above, wherein the lens unit comprises a group of lenses composed of a plurality of lenses stacked in an optical axis direction in a holder.

According to the present invention, there is provided a lens unit, comprising a group of lenses composed of a plurality of lenses stacked in an optical axis direction in a holder, wherein the light-shielding member explained above is provided between at least one pair of lenses.

According to the present invention, there is provided a camera module, comprising the lens unit explained above and an image pickup element for picking up an image of a subject through the lens unit.

According to the present invention, there is provided a light-shielding film for obtaining a light-shielding member, wherein front and back thereof can be distinguished visually, and by which arising of flare ghost is suppressed in a camera module incorporated in a lens unit, and also provided are a light-shielding member, a lens unit and a camera module formed by using the same.

### BRIEF DESCRIPTION OF DRAWINGS

FIG. 1 is a sectional view schematically showing a light-shielding film according to one mode of the present invention.

FIG. 2 is a disassembled perspective view schematically showing a lens unit and camera module for incorporating a light-shielding member according to one mode of the present invention.

### EXEMPLARY MODE FOR CARRYING OUT THE DISCLOSED SUBJECT MATTER

Below, the best modes for carrying out the invention will be explained, however, the present invention is not limited to the modes below and also includes those obtained by suitably modifying or improving the modes explained below based on ordinary knowledge of persons skilled in the art within the scope of the present invention.

As to a range of value in the present specification, an uppermost value or a lowermost value described in certain value ranges may be replaced by values indicated in the examples.

In the present specification, when there are a plurality of kinds of substances falling under each component in a composition, a content ratio or a content in each component in the composition indicates a content ratio or a content of a total of the plurality of kinds of substances being in the composition unless otherwise mentioned.

### Light-Shielding Film

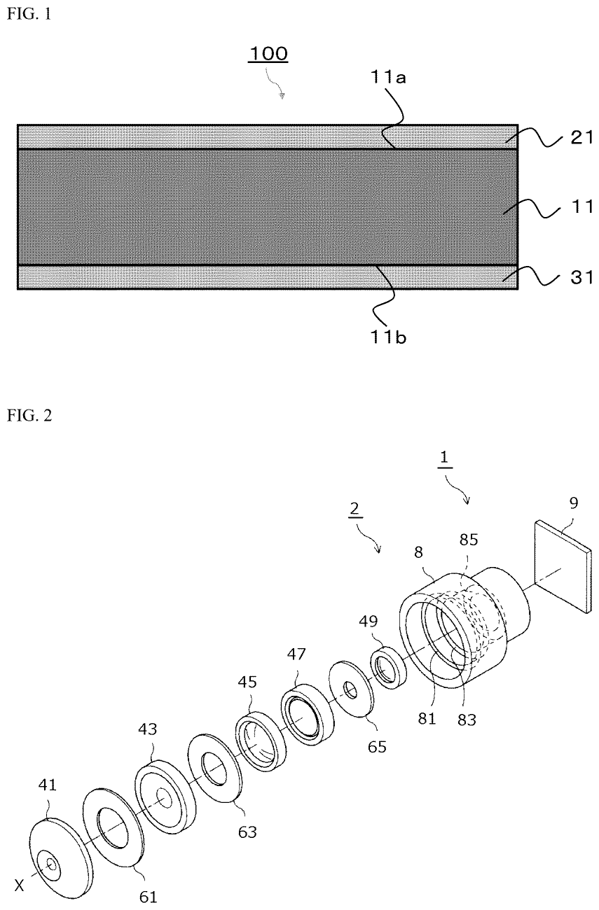

As shown in FIG. 1, a light-shielding film 100 according to one mode of the present invention comprises at least a substrate film 11, a first light-shielding layer 21 provided on a main surface 11a side of the substrate film 11 and a second light-shielding layer 31 provided on the other main surface 11b side. The light-shielding film 100 has a multilayer structure (three-layer structure) having the light-shielding layer 21, the substrate film 11 and the light-shielding layer 31 arranged in this order.

Here, “provided on a (the other) main surface side of the substrate film” not only means that light-shielding layers 21 and 31 are mounted directly on surfaces (for example, a main surface 11a and a main surface 11b) of the substrate film 11, but includes the mode where an optional layer (for example, an anchor layer and an adhesive layer, etc.) is provided between the surfaces of the substrate film 11 and the light-shielding layers 21 and 31. Also, a multilayer structure comprising at least a first light-shielding layer 21 and a second light-shielding layer 31 does not only mean the structure of stacking only the first light-shielding layer 21 and the second light-shielding layer 31 directly but includes the three-layer structure and a structure of furthermore providing an optional layer to the three-layer structure.

### -Substrate Film-

A kind of a substrate film 11 as an element of a light-shielding film 100 is not particularly limited as long as it is capable of supporting light-shielding layers 21 and 31. In terms of dimension stability, mechanical strength and weight reduction, etc. a synthetic resin film is preferably used. As specific examples of a synthetic resin film, a polyester film, ABS (acrylonitrile-butadiene-styrene) film, polyimide film, polystyrene film and polycarbonate film, etc. may be mentioned. Also, acrylic-type, polyolefin-type, cellulose-type, polysulfone-type, polyphenylene sulfide-type, polyether sulfone-type and polyether ether ketone-type films may be used. Among them, as a substrate film 11, a polyester film and polyimide film are preferably used. Especially a uniaxially or biaxially stretched films, particularly a biaxially stretched polyester film, are particularly preferable as they are excellent in mechanical strength and dimension stability. For a thermoresistant purpose, a uniaxially or biaxially stretched polyimide films are particularly preferable. They may be used alone or in combination of two or more kinds.

A thickness of a substrate film 11 may be set arbitrarily in accordance with required performance and use purpose and is not particularly limited. In terms of reducing weight and thickness, a thickness of a substrate film 11 is preferably 0.5 μm or more and 50 μm or less, more preferably 1 μm or more and 25 μm or less, furthermore preferably 4 μm or more and 10 μm or less and particularly preferably 5 μm or more and 7 μm or less. Note that in terms of improving adhesiveness with light-shielding layers 21 and 31, a surface of the substrate film 11 may be subjected to a variety of well-known surface treatments, such as an anchor treatment and a corona treatment.

An appearance of the substrate film 11 is not particularly limited and may be transparent, semitransparent or nontransparent. For example, a synthetic resin film of a foamed polyester film, etc. and a synthetic resin film containing carbon black or other black colorant or other pigment may be used, as well. Pigment to be contained is not particularly limited and either of resin-type particles and inorganic-type particles may be used. As resin type particles, for example, a melamine resin, benzoguanamine resin, benzoguanamine/melamine/formalin condensate, acrylic resin, urethane resin, styrene resin, fluororesin and silicone resin, etc. may be mentioned. As inorganic particles, silica, alumina, calcium carbonate, barium sulfate, titanium oxide, magnetite type black, copper, iron, manganese type black, titanium black carbon black and aniline black, etc. may be mentioned. These pigments may be used alone or in combination of two or more kinds.

A content of a pigment contained in a substrate film 11 is not particularly limited and may be set arbitrarily in accordance with required performance, etc. It is, for example, 0.3 % by mass or more, preferably 0.4 % by mass or more and, for example, 15 % by mass or less and preferably 12 % by mass or less or so with respect to the substrate film 11.

Before providing light-shielding layers 21 and 31 on surfaces of a substrate film 11, an anchor layer may be provided in order to improve adhesiveness between the surfaces of the substrate film 11 and the light-shielding layers 21 and 31. As an anchor layer, a urea type resin layer, melamine type resin layer, urethane type resin layer and polyester type resin, etc. may be applied. For example, a urethane type resin layer may be obtained by applying and curing a solution containing polyisocyanate and diamine, diol or other active hydrogen containing compound to surfaces of the substrate film 11. In the case of a urea type resin and melamine type resin, it is obtained by applying and curing a solution containing a water-soluble urea type resin or water-soluble melamine type resin to surfaces of a substrate film 11. A polyester type resin may be obtained by applying and drying a solution obtained by dissolving or diluting by an organic solvent (methylethyl ketone, toluene, etc.) to the surfaces of the substrate film 11.

### -Light-Shielding Layer -

Each of light-shielding layers 21 and 31 as one element of a light-shielding film 100 is a light-shielding film, wherein its layer surface includes 2% or less of (A), 4.5% or less of (B), 26 or less of (C) and 1.0 or more of (D).

Here, if it is configured that the outermost surfaces of the light-shielding layers 21 and 31 are exposed, each of the layer surfaces should have (A), (B), (C) and (D) as defined above. While when surfaces of the light-shielding layers 21 and 31 are covered with another layer, a surface of this another layer (namely, the outermost surface of the light-shielding film 100) should have (A), (B), (C) and (D) as defined above. Hereinafter, those surfaces are all referred to as “the outermost surface of the layer”.

Each of light-shielding layers 21 and 31 as one element of a light-shielding film 100 are light-shielding films, wherein its outermost surface of the layers includes 2% or less of (A), 4.5% or less of (B), 26 or less of (C) and 1.0 or more of (D) and, a difference of (B) between the outermost surface of the light-shielding layer 21 and that of the light-shielding layer 31 is set to be 2% or less and a difference of (C) between the outermost surface of the light-shielding layer 21 and that of the light-shielding layer 31 is set to be 4 or more. Furthermore, a difference of (A) between the outermost surface of the light-shielding layer 21 and that of the light-shielding layer 31 may be set to be 0.5% or less.

### -(A) Glossiness Degree Against Light With Incident Angle 60 °-

In the present specification, (A) is a value obtained by measuring a glossiness degree (specular glossiness) on an outermost surface of each of the light-shielding layers 21 and 31 against a light received at an incident angle of 60°by using a glossmeter (VG 7000 produced by NIPPON DENSHOKU Industries Co., Ltd.) based on JIS Z8741. In terms of preventing a flare ghost phenomenon due to irregular reflection of lights effectively, it is preferable that (A) on the outermost surface of each of the light-shielding layers 21 and 31 is 1.5% or less, more preferably 1% or less and furthermore preferably 0.7% or less. In terms of preventing a flare ghost phenomenon due to unnecessary lights, it is preferable that (A) on the outermost surface of the light-shielding layer 21 is 1% or less, more preferably 0.5% or less and furthermore preferably 0.3% or less. In terms of preventing a flare ghost phenomenon due to unnecessary lights, it is preferable that (A) on the outermost surface of the light-shielding layer 31 is 1.5% or less, more preferably 1% or less and furthermore preferably 0.7% or less.

### -(B) Reflectance Against Light Having a Wavelength of 550 nm-

(B) is a value obtained by measuring reflectance of an outermost surface of each of the light-shielding layers 21 and 31 against a light having a wavelength of 550 nm by using a spectral colorimeter (CM-5 produced by Konica Minolta Inc.) based on JIS Z8722. In terms of preventing a flare ghost phenomenon due to irregular reflection of lights furthermore effectively, it is preferable that (B) on the outermost surface of each of the light-shielding layers 21 and 31 is 4.4% or less, more preferably 4.2% or less and furthermore preferably 4.0% or less. In terms of preventing a flare ghost phenomenon due to unnecessary lights furthermore effectively and facilitating distinguishment of front and back visually, it is preferable that (B) on the outermost surface of the light-shielding layer 21 is 2.4% as an upper limit or less, more preferably 2.2% or less and furthermore preferably 2% or less. The lower limit is not particularly limited and is, for example, 0.8% or more preferably 1.0% or more and furthermore preferably 1.1% or more. In terms of furthermore facilitating distinguishment of the front and back visually, (B) on the outermost surface of the light-shielding layer 31 is 2.8% or more, more preferably 3.0% or more and furthermore preferably 3.1% or more.

### -(C) L Value in CIELAB Color Space System by SCE Method-

(C) is an index indicating a blackness degree and is a lightness L*value on the outermost surface in CIE 1976 L*a*b* (CIELAB) color space system on the surface by the SCE method. The SCE method is a specularly reflected light removal method, which means a method of measuring color by removing specularly reflected lights. Definition of the SCE method is defined in JIS Z8722: 2009. Since specularly reflected lights are removed in the SCE method, the color is close to the color actually viewed by human.

CIE is abbreviation of Commission Internationale de l'Eclairage, which means international committee on illumination. The CIELAB color space was adopted in 1976 in order to measure a color difference between perception and devices and is a uniform color space defined in JIS Z 8781:2013. Three coordinates in CIELAB are indicated by L*value, a*value and b*value. The L*value indicates lightness and expressed from 0 to 100. When L*value is 0, it indicates black, while it indicates white diffusion color when L*value is 100. The a*value indicates colors between red and green. When a*value is in minus, it indicates colors close to green, while when in plus, it indicates colors close to red. The b*value indicates colors between yellow and blue. When b*value is in minus, it indicates colors close to blue, while it indicates colors close to yellow when in plus.

The (C) is a value obtained by measuring a lightness L* value in CIE 1976 L*a*b* (CIELAB) color space system on the outermost surface of each of the light-shielding layers 21 and 31 by the SCE method by using a spectral colorimeter (CM-5 produced by Konica Minolta Inc.) based on JIS Z8781-4: 2013.

In terms of suppressing generation of flare ghost due to unnecessary lights and improving designability by emphasizing blackness, it is preferable that the outermost surfaces of the light-shielding layers 21 and 31 have (C) of 25 or less, more preferably 23 or less, respectively. Also in terms of the same points, the outermost surface of the light-shielding layer 21 has (C) of preferably 18 or less, more preferably 17 or less, furthermore preferably 16 or less, even more preferably 15 or less, furthermore preferably 14 or less and most preferably 13 or less. In terms of suppressing generation of flare ghost due to unnecessary lights and furthermore facilitating distinguishment of front and back thereof visually, the outermost surface of the light-shielding layer 31 has (C) of preferably 17 or more, more preferably 18 or more and furthermore preferably 19 or more.

### -(D) Optical Density-

(D) is a value obtained by using an optical density meter (X-rite 361T (ortho filter) produced by Nihon Heihan Kizai Kabushiki Kaisha), irradiating a vertical transmission light flux to the outermost surface of each of the light-shielding layers 21 and 31, and calculating by expressing a ratio with respect to a state without the light-shielding layers 21 and 31 in log (logarithms). In terms of providing higher light-shielding characteristic, the outermost surfaces of the light-shielding layers 21 and 31 have (D) of 1.0 or more, respectively. In terms of suppressing generation of flare ghost due to unnecessary lights, facilitating distinguishment of front and back thereof visually and attaining a higher light-shielding characteristic of the light-shielding layers, the outermost surface of the light-shielding layer 21 has (D) of preferably 2.0 or more and, in terms of attaining more preferable adhesiveness to the substrate, it is more preferably 2.0 or more and 2.4 or less. Also, in terms of suppressing generation of flare ghost due to unnecessary lights, facilitating distinguishment of front and back thereof visually and attaining a preferable adhesiveness to the substrate, the outermost surface of the light-shielding layer 31 has (D) of preferably 1.5 or less and more preferably 1.4 or less.

When stacking the light-shielding layers 21 and 31, the multilayer body has (D) of preferably 3.0 or more and 5.0 or less and more preferably 3.5 or more and 4.0 or less. Here, for example, when using a light-shielding layer 21 having (D) of 2.0 or more and a light-shielding layer 31 having (D) of 1.0 or more and 1.5 or less to configure a multilayer body having (D) in total of 3.0 or more and 5.0 or less and setting optical densities different on the front and back surfaces of the multilayer body, the front and back of the multilayer structure become clearer, which is preferable.

### -Composition Example-

As components of the light-shielding layers 21 and 31 having characteristics as above, a resin component, particle and colorant/conductive agent may be blended.

### Resin Component-

A resin component serves as a binder of particle and colorant/conductive agent. A material of a resin component is not particularly limited and either of a thermoplastic resin and thermosetting resin may be used. As a thermosetting resin, specifically, an acrylic-type resin, urethane-type resin, phenol-type resin, melamine-type resin, urea-type resin, diallyl phthalate-type resin, unsaturated polyester-type resin, epoxy-type resin and alkyd-type resin, etc. may be mentioned. As a thermoplastic resin, a polyacrylic ester resin, polyvinyl chloride resin, butyral resin and styrene-butadiene copolymer resin, etc. may be mentioned. In terms of heat resistance, moisture resistance, solvent resistance and surface hardness, a thermosetting resin is preferably used. As a thermosetting resin, when considering flexibility and strength, an acrylic resin is particularly preferable.

By adding a curing agent as a component of the light-shielding layers 21 and 31, crosslinking of a resin component can be accelerated. As a curing agent, a urea compound having a functional group, melamine compound, isocyanate compound, epoxy compound, aziridine compound and oxazoline compound, etc. may be used. Among them, isocyanate compound is particularly preferable. A blending ratio of the curing agent is preferably 10 to 50 % by mass with respect to 100 % by mass of a resin component. When a curing agent is added in the range above, a light-shielding layer having more preferable hardness can be obtained, and even in the case of rubbing against other member, optical characteristics on the surfaces of the light-shielding layers 21 and 31 can be maintained for a long period of time.

When using a curing agent, a reaction catalyst may be used together so as to accelerate a reaction thereof. As a reaction catalyst, for example, ammonia and aluminum chloride, etc. may be mentioned. A ratio of a reaction catalyst to be contained in the composition is, with respect to 100 parts by mass of a curing agent, preferably 0.1 % by mass or more and 10 % by mass or less.

### -Particle, Colorant/Conductive Agent-

The light-shielding layers 21 and 31 may contain a particle and colorant/conductive agent. As a particle and colorant/conductive agent, for example, by using two or more particle groups having different particle diameters and particle distributions, it is possible to control the predetermined optical characteristics as above on an outermost surface of each of the light-shielding layers 21 and 31 so as to be in the range defined in the present invention.

When using two particle groups of different sizes, it is preferable that a particle diameter of a large particle group is 10 to 40 times a particle diameter of a small particle group. When using three or more particle groups, a particle diameter of the largest particle group and that of the smallest particle group should be adjusted to satisfy the relationship as above.

Below, an explanation will be made by referring to a large particle group as a large particle 1 and a small particle group as a small particle 2.

It is preferable that light-shielding layers 21 and 31 according to one mode contain as particle groups a large particle 1 having an average particle diameter of 2 μm to 6 μm and a small particle 2 having an average particle diameter of 0.06 μm to 0.4 μm. An average particle diameter of the large particle 1 is more preferably 3 μm to 5 μm and furthermore preferably 3 μm to 4 μm. An average particle diameter of the small particle 2 is preferably 0.06 μm to 0.4 μm and more preferably 0.1 μm to 0.3 μm.

By combining the large particle 1 and small particle 2 having particle diameters as above, the small particle 2 is buried between large particles 1 (a concave portion) and the predetermined optical characteristics as above on the outermost surfaces of the light-shielding layers 21 and 31 can be controlled more optimally to be in the defined range of the present invention.

A content of particle is, depending on an average particle diameters and particle distributions of particle groups, film thicknesses of the light-shielding layers 21 and 31 and a surface shape of a substrate film 11, preferably 20% by volume to 50% by volume assuming that a total of the light-shielding layers 21 and 31 is 100% by volume. A mix ratio of the large particle 1 and small particle 2 is not particularly limited as long as the predetermined optical characteristics on the outermost surfaces of the light-shielding layers 21 and 31 can be adjusted to be in a range defined in the present invention, and is preferably 1.5:1 to 3.5:1 (a volume accounting for the large particle 1: a volume accounting for the small particle 2). Note that a volume content ratio (volume occupation rate) of the particles in the light-shielding layers 21 and 31 can be obtained by converting to an area occupation rate calculated by an image analysis, etc. from a sectional view of the light-shielding layers 21 and 31.

As a large particle 1, either of resin-type particles and inorganic-type particles may be used. As resin-type particles, for example, a melamine resin, benzoguanamine resin, benzoguanamine/melamine/formalin condensate, acrylic resin, urethane resin, styrene resin, fluororesin and silicone resin, etc. may be mentioned. As inorganic-type particles, silica, alumina, calcium carbonate, barium sulfate, titan oxide and carbon, etc. may be mentioned. They may be used alone or in combination of two or more kinds.

To obtain more excellent characteristics, it is preferable to use inorganic-type particles as the large particle 1. By using inorganic-type particles as the large particle 1, a light-shielding film 100 with a lower glossy and high optical density can be obtained. As an inorganic particle to be used as the large particle 1, silica is preferable. A shape of the large particle 1 is not particularly limited, but it is preferable to use a particle group having a sharp particle distribution in order to control the predetermined optical characteristics on the respective outermost surfaces of the light-shielding layers 21 and 31 to be in the ranges defined in the present invention.

In order to decrease (A), a particle in indefinite form is preferably used. It is particularly preferable to use a porous indefinite-shaped silica particle. When using a particle group as above, lights refract repeatedly inside and surface of the large particle 1, consequently, (A) can be furthermore decreased.

To suppress light reflection, the large particle 1 may be colored black by using an organic type or inorganic type colorant. As a colored material, composite silica, conductive silica and black silica, etc. may be mentioned.

As composite silica, for example, what obtained by synthesizing and compositing carbon black and silica at a nano level may be mentioned. As conductive silica, for example, what obtained by coating silica particles with conductive particles, such as carbon black, may be mentioned. As black silica, for example, natural ore containing graphite in silica may be mentioned.

Also, a material of the small particle 2 is not particularly limited and either and either of resin-type particles and inorganic-type particles may be used. As resin-type particles, for example, a melamine resin, benzoguanamine resin, benzoguanamine/melamine/formalin condensate, acrylic resin, urethane resin, styrene resin, fluororesin and silicone resin, etc. may be mentioned. As inorganic-type particles, silica, alumina, calcium carbonate, barium sulfate, titan oxide and carbon, etc. may be mentioned. They may be used alone or in combination of two or more kinds.

As small particle 2, for example, carbon black, etc. to be added as a colorant/conductive agent may be used. By using carbon black as the small particle 2, the light-shielding layers 21 and 31 are colored, so that an antireflection effect is enhanced and a preferable antistatic effect can be also obtained.

### -Optional Components-

In one mode, as a component of the light-shielding layers 21 and 31, a leveling agent, thickener, pH adjusting agent, lubricant, dispersant and defoaming agent, etc. may be furthermore added in accordance with need.

Thicknesses of the light-shielding layers 21 and 31 are not particularly limited, but an average film thickness is preferably 2 μm or more and 20 μm or less. An upper limit of an average film thickness of the light-shielding layers 21 and 31 is more preferably 15 μm and furthermore preferably 10 μm. In the present invention, even when a thickness of the light-shielding layer is 5 μm or less, it is possible to obtain a light-shielding film 100 having low glossiness, a high optical density, low reflectance and high blackness degree. Note that an average film thickness of the light-shielding layers 21 and 31 is a height including parts protruding due to large particle 1 and small particle 2 from a surface of a substrate film 11. The average film thickness of the light-shielding layers can be measured based on JIS K7130.

In terms of reducing weight and thickness, a total thickness of a light-shielding film 100 is preferably 0.5 μm or more and 50 μm or less, more preferably 1 μm or more, furthermore preferably 5 μm or more, more preferably 40 μm or less and furthermore preferably 25 μm or less.

### -Difference of (B), Difference of (C) and Adjustment Method-

A light-shielding film 100 according to one mode of the present invention is characterized by applying the configuration that a difference of (B) between the outermost surface of the light-shielding layer 21 and that of the light-shielding layer 31 is 2% or less and a difference of (C) between the outermost surface of the light-shielding layer 21 and that of the light-shielding layer 31 is 4 or more, wherein the outermost surfaces of the light-shielding layers 21 and 31 have (A) of 2% or less, (B) of 4.5% or less, (C) of 26 or less and (D) of 1.0 or more. In the light-shielding layers 21 and 31 having specific optical characteristics as above on outermost surfaces thereof, as a result of making (B) and (C) on the outermost surfaces of the light-shielding layers 21 and 31 different from each other, the front and back of the light-shielding film 100 can be determined visually without touching based on the difference of the reflection and blackness of the appearance.

In terms of suppressing generation of flare ghost due to unnecessary lights and facilitating distinguishment of front and back visually, the difference of (B) between the outermost surfaces of the light-shielding layer 21 and light-shielding layer 31 is preferably 1.5% or less and more preferably 1.35% or less. To obtain a difference of (B) as such, for example, the outermost surface of the light-shielding layer 21 is set to be 2.4% or less and the outermost surface of the light-shielding layer 31 is set to be 2.8% or more and 4.4% or less as explained above.

As an adjustment method of (B) on the outermost surfaces of the light-shielding layers 21 and 31, for example, a method of making a content of black particle different between the light-shielding layer 21 and light-shielding layer 31, a method of using particle groups having different shapes respectively in the light-shielding layers 21 and 31, a method of using particle groups having different particle diameters in the light-shielding layers 21 and 31, a method of using particle groups having different particle distributions between the light-shielding layers 21 and 31, a method of using particle groups of different materials (for example, difference of organic and inorganic, etc. It will be the same hereinafter.) respectively in the light-shielding layers 21 and light-shielding layer 31, and a method of making thicknesses different between the light-shielding layer 21 and the light-shielding layer 31, etc. may be mentioned. However, it is not limited to those and a variety of methods may be used alone or properly combined as the adjusting methods.

In terms of facilitating distinguishment of front and back visually, a difference of (C) on the outermost surfaces of the light shielding layers 21 and 31 is preferably 4.5 or more and more preferably 5 or more. To obtain the difference of (C) as above, for example, (C) on the outermost surface of the light-shielding layer 21 should be set to be 18 or less and (C) on the outermost surface of the light-shielding layer 31 should be set to be 17 or more and 25 or less as explained above.

As an adjustment method of (C) on the outermost surfaces of the light-shielding layers 21 and 31, for example, a method of making a content of black particle different between the light-shielding layer 21 and light-shielding layer 31, a method of using particle groups having different shapes respectively in the light-shielding layers 21 and 31, a method of using particle groups having different particle diameters respectively in the light-shielding layers 21 and 31, a method of using particle groups having different particle distributions between the light-shielding layers 21 and 31, a method of using particle groups of different materials respectively in the light-shielding layers 21 and light-shielding layer 31, a method of making thicknesses different between the light-shielding layer 21 and the light-shielding layer 31, a method of containing a plurality of particle groups having different particle diameters only in one of the light-shielding layers 21 and 31, a method of containing a plurality of particle groups of different materials only in one of the light-shielding layers 21 and 31 and a method of containing a plurality of particle groups having different shapes only in one of the light-shielding layers 21 and 31, etc. may be mentioned, however, it is not limited to those methods. A variety of methods may be used alone or properly combined as the adjusting methods.

### -Difference of (A) and Adjustment Method-

In addition to the difference of (B) and (C) on the outermost surfaces of the light-shielding layers 21 and 31, when making (A) different on the respective outermost surfaces of the light-shielding layers 21 and 31, it may be set arbitrarily considering the suppression of generation of flare ghost due to unnecessary lights and is not particularly limited and is preferably 0.45% or less. To obtain a difference of (A) as above, for example, (A) on the outermost surface of the light-shielding layer 21 is set to be 1% or less and (A) on the outermost surface of the light-shielding layer 31 to be 1.5% or less as explained above.

As an adjustment method of (A) on the outermost surfaces of the light-shielding layers 21 and 31, for example, a method of making a content of black particle different between the light-shielding layer 21 and light-shielding layer 31, a method of using particle groups having different shapes respectively in the light-shielding layers 21 and 31, a method of using particle groups having different particle diameters respectively in the light-shielding layers 21 and 31, a method of using particle groups having different particle distributions between the light-shielding layers 21 and 31, a method of using particle groups of different materials respectively in the light-shielding layers 21 and light-shielding layer 31, a method of making thicknesses different between the light-shielding layer 21 and the light-shielding layer 31, a method of containing a plurality of particle groups having different particle diameters only in one of the light-shielding layers 21 and 31, a method of containing a plurality of particle groups of different materials only in one of the light-shielding layers 21 and 31, and a method of containing a plurality of particle groups having different shapes only in one of the light-shielding layers 21 and 31, etc. may be mentioned, however, it is not limited to those methods. A variety of methods may be used alone or properly combined as the adjusting methods.

In terms of providing sufficient antistatic performance, the light-shielding layers 21 and 31 have a surface resistivity of less than 1.0×10⁸Ω, more preferably less than 1.0×10⁵Ω, and furthermore preferably less than 5.0×10⁴Ω. Note that the surface resistivity in the present specification is values measured based on JIS K6911: 1995.

### Production Method of Light-Shielding Film

A method of producing a light-shielding film 100 according to one mode is not particularly limited as long as those having the configuration as explained above can be obtained. In terms of producing the light-shielding layers 21 and 31 on a substrate film 11 with good reproducibility simply at low cost, a conventionally well-known application method, such as doctor coating, dip coating, roll coating, bar coating, die coating, blade coating, air knife coating, kiss coating, spray coating and spin coating, may be used preferably.

For example, by applying an application liquid containing the components above (a resin component, particle and colorant/conductive agent) and optional component blended as needed in a solvent (an organic solvent or water) to a main surface of the substrate film 11, drying and then performing a thermal treatment or pressure treatment, etc. as needed, light-shielding layers 21 and 31 can be formed on the substrate film 11. As a solvent to be used in the solvent of the application liquid, for example, methylethylketone, toluene, propylene glycol monomethyl ether acetate, ethyl acetate, butyl acetate, methanol, ethanol, isopropyl alcohol and butanol, etc. may be used. To improve adhesiveness of the light-shielding layers 21 and 31 to the substrate film 11, an anchor treatment and corona treatment, etc. can be performed in accordance with need. Furthermore, a primer layer, adhesive layer or other intermediate layer can be also provided between the substrate film 11 and the light-shielding layers 21 and 31 if needed. Also, by a variety of well-known methods, such as compression molding, injection molding, blow molding and transfer molding, extrusion molding, a light-shielding film 100 having a desired shape can be obtained easily, as well. After being molded into a sheet shape, it may be subjected to vacuum forming and pressure forming, etc.

In the light-shielding film 100 according to one mode, a first light-shielding layer 21 and second light-shielding layer 31, which are light-shielding films, wherein the respective outermost surfaces have (A) of 2% or less, (B) of 4.5% or less, (C) of 26 or less and (D) of 1.0 or more, and a difference of (B) between the outermost surface of the light-shielding layer 21 and that of the light-shielding layer 31 is set to be 2% or less and a difference of (C) between the outermost surface of the light-shielding layer 21 and that of the light-shielding layer 31 is set to be 4 or more, are used. Therefore, by using it as a light-shielding member of a lens unit and camera module, etc., unnecessary lights can be removed sufficiently, generation of flare ghost can be suppressed and a quality of picked up image can be improved.

Moreover, in the multilayer structure explained above (that is, the light-shielding layer 21 and light-shielding layer 31 having specific optical characteristics on their outermost surfaces), a difference of (B) between the outermost surface of the light-shielding layer 21 and that of the light-shielding layer 31 is adjusted to be 2% or less and a difference of (C) between the outermost surface of the light-shielding layer 21 and that of the light-shielding layer 31 is adjusted to be 4 or more, therefore, it is possible to distinguish the front and back surfaces of the light-shielding film 100 easily visually without touching based on the reflection and blackness of the appearance.

Note that the present invention can be carried out by arbitrarily modifying within the range not beyond the scope of the present invention. For example, in the embodiment above, a mode of providing the light-shielding layer 21 and light-shielding layer 31 to the front and back of the substrate film 11 was shown, but it may be a multilayer structure of light-shielding layers 21 and 31 (two-layer structure) without providing a substrate film 11. Alternatively, the light-shielding layers 21 and 31 may be formed of two or more light-shielding films. For example, a multilayer light-shielding layer obtained by stacking a light-shielding film 21a and a light-shielding film 21b may be used as the light-shielding layer 21. It is the same for the light-shielding layer 31, as well. In this case, a multilayer body of the light-shielding film 21a and light-shielding film 21b should satisfy the variety of performances and physical properties explained above, which are required to the outermost surface of the light-shielding layer 21. It is the same for the light-shielding layer 31, as well.

### Camera Module, Lens Unit and Light-Shielding Member

As shown in FIG. 2, a camera module 1 according to one mode of the present invention comprises a lens unit 2. The lens unit 2 comprises a group of lenses composed of five lenses 41, 43, 45, 47 and 49 stacked in an optical axis direction X. The number of lenses to compose the group of lenses is not limited to 5. In the present example, among five lenses 41, 43, 45, 47, and 49, light-shielding members 61, 63 and 65 are provided between three pairs of lenses (lenses 41 and 43, lenses 43 and 45, and lenses 47 and 49). Both of the group of lenses and the light-shielding members 61, 63 and 65 are configured by a resin or metal, etc. and placed in a cylindrical holder 8 having multiple steps (a barrel). The holder 8 of the present example is provided with three step parts 81, 83 and 85 on the inner circumferential part, and the group of lenses and the light-shielding members 61, 63 and 65 are held and arranged at predetermined positions in the holder 8 in a state of being arranged and stacked on the same optical axis by using the step parts 81, 83 and 85. A various kinds of lenses (a convex lens and concave lens, etc.) may be used as the lenses 41, 43, 45, 47 and 49. It does not matter if the curved surface may be spherical or aspherical and if a material thereof is a resin (for example, a cyclic olefin-type resin (COC and COP), a polycarbonate-type resin, a liquid crystal polymer, etc.) or glass.

The camera module 1 comprises an image pickup element 9 together with the lens unit 2. The image pickup element 9 is arranged on an optical axis of the lens unit 2 and picks up images of a subject through the lens unit 2. The image pickup element 9 is configured by a CCD image sensor or a CMOS image sensor, etc.

The light-shielding members 61, 63 and 65 of the present example are light-shielding plates having a circular-shape (a ring shape) appearance in a plan view and have a shape having a cylindrical hollow portion at the center part in a sectional view and formed by cutting out the light-shielding film 100 shown in FIG. 1 to be a ring shape. Therefore, the light-shielding members 61, 63 and 65 have the same multilayer structure as the light-shielding film 100 shown in FIG. 1. The light-shielding member 63 and 65 have the same structure as the light-shielding member 61 other than that each of them has a different outer circumferential size and different outer circumferential size of the hollow portion.

In the light-shielding members 61, 63 and 65 according to one mode, the first light-shielding layer 21 and the second light-shielding layer 31, which are light-shielding films, wherein the respective outermost surfaces have (A) of 2% or less, (B) of 4.5% or less, (C) of 26 or less and (D) of 1.0 or more, and a difference of (B) between the outermost surface of the light-shielding layer 21 and that of the light-shielding layer 31 is set to be 2% or less and a difference of (C) between the outermost surface of the light-shielding layer 21 and that of the light-shielding layer 31 is set to be 4 or more, are also used. Therefore, by using those as a light-shielding member of a lens unit and camera module, etc., unnecessary lights can be removed sufficiently, generation of flare ghost can be suppressed and a quality of picked up images can be improved.

Moreover, in the multilayer structure explained above (that is, the light-shielding layer 21 and the light-shieling layer 31 having specific optical characteristics on their outermost surfaces), a difference of (B) between the outermost surface of the light-shielding layer 21 and that of the light-shielding layer 31 is adjusted to be 2% or less and a difference of (C) between the outermost surface of the light-shielding layer 21 and that of the light-shielding layer 31 is adjusted to be 4 or more, therefore, it is possible to distinguish the front and back surfaces of the light-shielding members 61, 63 and 65 easily visually without touching based on difference of the reflection impressions and blackness of the appearance. Therefore, a lens unit 2 and camera module 1 using the light-shielding members 61, 63 and 65 can suppress defectives in incorporating or other failures in production caused by misrecognition of the front and back surfaces even during storing and incorporating.

The present invention may be carried out by arbitrarily modifying within a range of not beyond the scope of the present invention. For example, an outer shape of the light-shielding film 100 (light-shielding members 61, 63 and 65) may be optional, for example, a rectangular shape, square shape, hexagonal shape and other polygonal shapes, oval shape and irregular shape, etc. when seen on plane. Also, a shape of the hollow portion of the light-shielding members 61, 63 and 65 is formed to be circular when seen on plane in the present embodiment, however, the outer shape is not particularly limited. For example, any shape, such as a rectangular shape, square shape, hexagonal and other polygonal shapes, oval shape and irregular shape when seen on plane, may be applied.

### DESCRIPTION OF NUMERICAL NOTATIONS

. . . light-shielding film
   11. . . substrate film
      11a . . . surface (main surface)
      11b . . . surface (main surface)
   21 . . . light-shielding layer (first light-shielding layer)
   31 . . . light-shielding layer (second light-shielding layer)
1 . . . camera module
2 . . . lens unit
   41, 43, 45, 47 and 49. lens
   61, 63, 65 . . . light-shielding member
   8 . . . holder
. . . image pickup element

1. A light-shielding film for obtaining a light-shielding member for optical devices,
comprising at least a first light-shielding layer and a second light-shielding layer,
wherein
the first light-shielding layer and the second light-shielding layer have (A), (B), (C) and (D) of 2% or less, 4.5% or less, 26 or less and 1.0 or more on their outermost surfaces of surfaces formed with the respective layers;
a difference of the (B) and a difference of the (C) are 2% or less and 4 or more, respectively, between an outermost surface of a surface formed with the first light-shielding layer and an outermost surface of a surface formed with the second light-shielding layer;
the first light-shielding layer and the second light-shielding layer are configured to comprise a plurality of particle groups having different particle diameters, comprising a large particle having an average particle diameter of 2 μm to 6 μm and a small particle having an average particle diameter of 0.06 μm to 0.4 μm as the particle groups;
(A) is a glossiness degree against a light having an incident angle of 60°,
(B) is reflectance against a light having a wavelength of 550 nm,
(C) is an L value in the CIELAB color space system by SCE method, and
(D) is an optical density.

2. The light-shielding film according to claim 1, wherein a difference of the (A) is 0.5% or less between an outermost surface of a surface formed with the first light-shielding layer and an outermost surface of a surface formed with the second light-shielding layer.

3. The light-shielding film according to claim 1, wherein an outermost surface of a surface formed with the first light-shielding layer has the (B) of 2.4% or less.

4. The light-shielding film according to claim 3, wherein an outermost surface of a surface formed with the second light-shielding layer has the (B) of 2.8% or more.

5. A light-shielding member to be used in a lens unit, formed of the light-shielding film according to claim 1, wherein the lens unit comprises a group of lenses composed of a plurality of lenses stacked in an optical axis direction in a holder.

6. A lens unit, comprising a group of lenses composed of a plurality of lenses stacked in an optical axis direction in a holder, wherein a light-shielding member according to claim 5 is provided between at least one pair of lenses.

7. A camera module, comprising the lens unit according to claim 6 and an image pickup element for picking up an image of a subject through the lens unit.

8. The light-shielding film according to claim 1, wherein a large particle having an average particle diameter of 2 μm to 6 μm comprises composite silica colored black with a colorant.

9. The light-shielding film according to claim 1, wherein an average particle diameter of a large particle is 10 to 40 times an average particle diameter of a small particle.

10. The light-shielding film according to claim 1, wherein a volume ratio of a large particle having an average particle diameter of 2 μm to 6 μm in the respective light-shielding layers is 1.5 to 3.5 with respect to a volume of a small particle having an average particle diameter of 0.06 μm to 0.4 μm in the respective light-shielding layers.

11. The light-shielding film according to claim 8, wherein a volume ratio of a large particle having an average particle diameter of 2 μm to 6 μm in the respective light-shielding layers is 1.5 to 3.5 with respect to a volume of a small particle having an average particle diameter of 0.06 μm to 0.4 μm in the respective light-shielding layers.

12. The light-shielding film according to claim 1, wherein a small particle having an average particle diameter of 0.06 μm to 0.4 μm comprises carbon black.

13. The light-shielding film according to claim 8, wherein a small particle having an average particle diameter of 0.06 μm to 0.4 μm comprises carbon black.
